(19) United States
(12) Patent Application Publication
(10) Pub. No.: US 2008/0309986 A1
(43) Pub. Date: Dec. 18, 2008

(54) Binary Data Relay Systems and Methods of Real-Time Communication of Binary Data Through a Peer-To-Peer Network

(76) Inventors: Michael B. Coffee, Alpharetta, GA (US); Clifford J. Schornak, Marietta, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/199,203

(22) Filed: Aug. 27, 2008

Related U.S. Application Data
(63) Continuation of application No. PCT/US07/67658, filed on Apr. 27, 2007.
(60) Provisional application No. 60/796,017, filed on Apr. 28, 2006.

(51) Int. Cl. H04N 1/00

(52) U.S. Cl. 358/407

(57) ABSTRACT

Binary data relay systems and methods are disclosed to allow users of peer-to-peer (P2P) communications networks designed for voice transport to send facsimile (fax) messages between P2P endpoints by using a computer (102, 104) suitably connected to the network (164). Although not limited to this implementation, this connection preferably uses the Internet to effect the connection between endpoint computers (102, 104). The computer (102, 104) may also be suitably connected to a facsimile terminal (160, 162). The binary data relay systems and methods provide the facsimile communications function, such as that usually provided by a stand-alone Group 3 facsimile terminal (160, 162), over the P2P network (164) intended for voice transmission, such as but not limited to, the Skype network. Such P2P network (164) is an overlay of the Internet, but is not limited to the Internet.

### CROSS-REFERENCE TO RELATED APPLICATION

This application claims priority to co-pending U.S. provisional patent application entitled, “Binary Data Relay Systems and Methods for Real-Time Communication of Binary Data Through a Peer-to-Peer Network”, having Ser. No. 60/796,017, filed Apr. 28, 2006, which is entirely incorporated herein by reference.

### FIELD OF THE INVENTION

The present invention relates to computer-based communications systems and methods, and more particularly, to systems and methods for providing binary-data transport (such as but not limited to, a facsimile function) across a packet-based data network.

### BACKGROUND

Even with the advent of e-mail, facsimile (fax) remains an important and ubiquitous form of business communications. Virtually all businesses use fax; with some, it is critical to the business's mission. Some large multi-location enterprises send thousands of faxes every day between offices, spending tens-of-thousands of dollars every year on telephone toll charges.

The use of the Internet as an application platform for real-time media transport has disintermediated telecommunications. Users can transport voice calls across the Internet without the involvement of telephone companies. One of the earliest such services was that of Net2Phone, which offered PC-to-PC communications for a fee paid to the company, not unlike a telephone company, but much less expensive.

Another service is that of Skype, which offers a peer-to-peer (P2P) no-fee service. Subscribers download the Skype software and equip their computer with the equivalent of a telephone headset. The Skype P2P technology is based on that developed for the Napster and KaZaA P2P music-sharing network. In general, after Skype P2P call setup, the user's voice is compressed to reduce bandwidth requirements and transported across the Internet to the correspondent computer where it is decompressed and streamed out as isochronous audio data. The Skype P2P technology is characterized by a method of traversing firewalls and handling Network Address Translation (NAT) to allow Internet packets to flow in real time between the two correspondent Skype clients. Although there are other P2P networks, such as Napster, File-Sharing, Collaboration, Freenet, and Gnutella, these networks are based on open-source software and are intended for data-file exchange, not real-time media data transfer, such as that required for a voice or a fax call.

Furthermore, in order to lower the required bandwidth for voice communications over the data network, low-bit-rate compression algorithms are sometimes used to transport a voice call. Many of these algorithms are specifically designed to compress human speech, resulting in their unsuitability to transport modem signals, which is necessary to transport a facsimile modem signal.

It would be advantageous if there were systems and methods for enabling real-time fax communications over P2P overlay data networks.

### SUMMARY

The present invention provides various embodiments of binary data relay systems and methods that enable real time streaming transport of binary data through a data network between first and second computers configured for peer-to-peer (P2P) communications.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a diagram of a network that includes at least a first computer system and a second computer system according to an embodiment of the present invention.

FIG. 2 is a diagram of a network that allows two endpoint fax terminals to use the ITU (International Telecommunications Union) T.30 standard Group 3 (G3) fax protocol for communications over the voice-based public switched telephone network (PSTN) in combination with a packet-based data network.

FIG. 3 is a diagram showing an embodiment of the binary data relay system for modulating and demodulating the analog modem signal, which the G3 fax terminal uses to communicate across the PSTN's time-division multiplexed (TDM) network.

FIG. 4 is a diagram of an embodiment of the binary data relay system of FIG. 3 showing how it utilizes third-party software for the interfaces with the local terminal and the P2P network.

FIG. 5 is a diagram showing an embodiment of the binary data relay system of FIG. 4 that supports the T.30-based facsimile transaction between two standard G3 fax terminals by rendering the P2P network transparent to the G3 terminals.

FIG. 6 is a diagram showing a fax transaction between a legacy terminal on the right, suitably connected to a computer equipped with an embodiment of the binary data relay system, with the computer on the left, which terminates the fax transaction on the user's computer, rather than a connected fax terminal.

FIG. 7 is a diagram showing an embodiment to implement the functions of the computer on the left side of FIG. 6.

FIG. 8 is a diagram showing an alternative to interconnecting the modem function with the fax relay function, as is shown in FIG. 3, wherein the modems are connected directly to the local T.30 protocol software.

### DETAILED DESCRIPTION

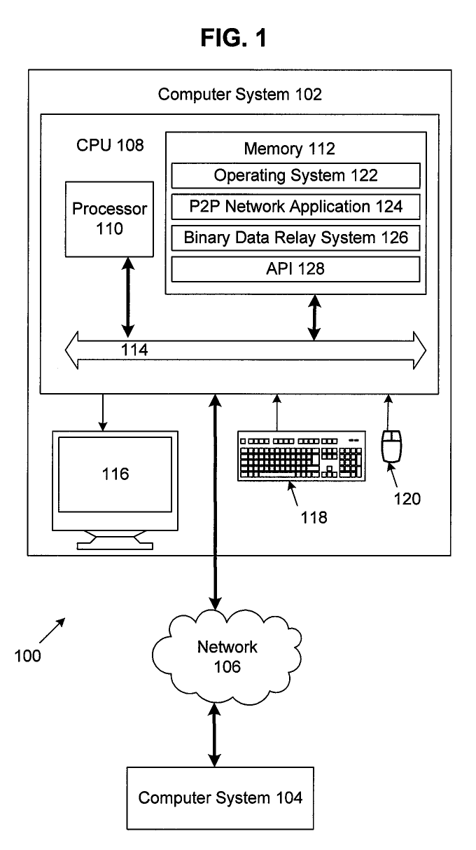

With reference to FIG. 1, shown is a data communications network 100 that includes, for example, a first computer system 102 and a second computer system 104, both which are coupled to a network 106. In this respect, the network 106 may be, for example the Internet, intranets, wide area networks (WANs), local area networks, wireless networks, or other suitable networks, etc., or any combination of two or more such networks. In addition, other computer systems, servers, or other devices may be coupled to the network 106.

The first computer system 102 and the second computer system 104 may be, for example, a desktop, a laptop, a palm or hand held computer, such as a personal digital assistant or any other device with like capability. The second computer system 104 may include all or some of the features of the first computer system 102.

The first computer system 102 includes, for example, a central processing unit (CPU) 108, which includes a processor circuit with a processor 110, and a memory 112, both of which are coupled to a local interface 114. The local interface 114, may be, for example, a data bus with an accompanying control/address bus as can be appreciated by those with ordinary skill in the art. The computer system 102 may also include various peripheral devices such as, for example, a display device 116, keyboard 118, and a mouse 120. The computer system 102 may also include other peripheral devices such as a keypad, touch pad, touch screen, microphone, scanner, joystick, biomedical data input device, or one or more push buttons, etc. The peripheral devices may also include indicator lights, speakers, printers, etc. The display device may be, for example, a cathode ray tube (CRT), a liquid crystal display screen, gas plasma-based flat panel display, or other type of display device, etc.

Stored in the memory 112 and executable by the processor 110 are a number of software components, including an operating system 122, a peer-to-peer (P2P) network application 124, a binary data relay system 126, and an application programming interface (API) 128. Examples of executable programs may be, for example, a complied program that can be translated into machine code in a format that can be loaded into a random access portion of the memory 112 and run by the processor 110, or source code that may be expressed in proper format, such as object code that is capable of being loaded into a random access portion of the memory 112 and executed by the processor 110, etc. An executable program may be stored in any portion or component of the memory including, for example, random access memory, read-only memory, a hard drive, compact disk (CD), floppy disk, USB flash drive, or other memory components.

The P2P network application 124 configures the computer 102 to use a P2P network, such as but not limited to, that provided by Skype. The binary data relay system 126 implements a fax relay function using the application interfaces provided by the P2P network's developer. Such network service providers offer software that permits developers to create applications that enhance the value of the network (software developer's kits or SDKs), benefiting the network provider, the user, and the developer of the enhanced software. Embodiments of the present invention may utilize SDKs to implement the fax relay function.

In other embodiments of the present invention, the binary data relay system 126 supports the use of Group 3 (G3) fax terminals suitably connected to a client's computer via a computer-to-POTS (plain old telephone service) converter, such as a USB telephone adapter or device.

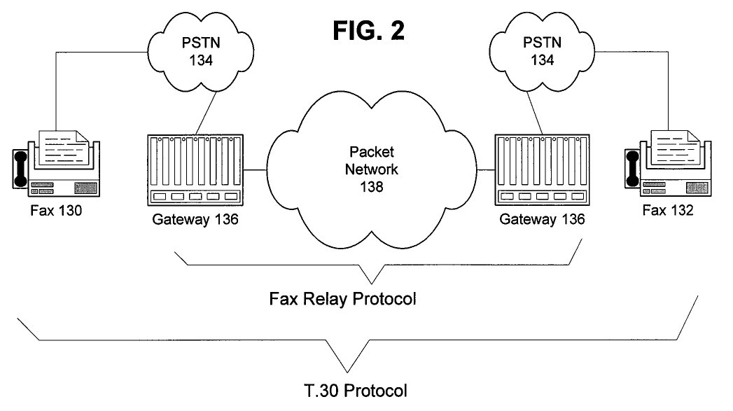

FIG. 2 is a diagram of a network that allows two endpoint fax terminals 130, 132 to use the ITU (International Telecommunications Union) T.30 standard G3 fax protocol for communications over the voice-based public switched telephone network (PSTN) 134 via a gateway 136 in combination with a packet-based data network 138, such as the Internet.

The binary data relay system 126 performs a fax relay function that allows two endpoint fax terminals or fax servers to use the ITU T.30 standard GP3 fax protocol for communications over the packet network, even though T.30 was only intended by its developers for use over the PSTN, which uses a time-division multiplexed (TDM) transport. The fax relay function serves to render the interposing packet network transparent to the endpoint T.30 terminals. Examples of industry-standard fax relay protocols that can be employed in connection with the binary data relay system 126 are the ITU T.38, the Frame Relay Forum's FRF.11.1, and the ITU's I.366.2 for ATM networks, the entire disclosures of which are incorporated herein by reference. These industry-standard fax relay protocols utilize full access to the network's transport mechanism. The preferred embodiment of the binary data relay system 126 does not have direct access to the P2P network's transport mechanism, and uses a character data transfer facility offered by the P2P network developer.

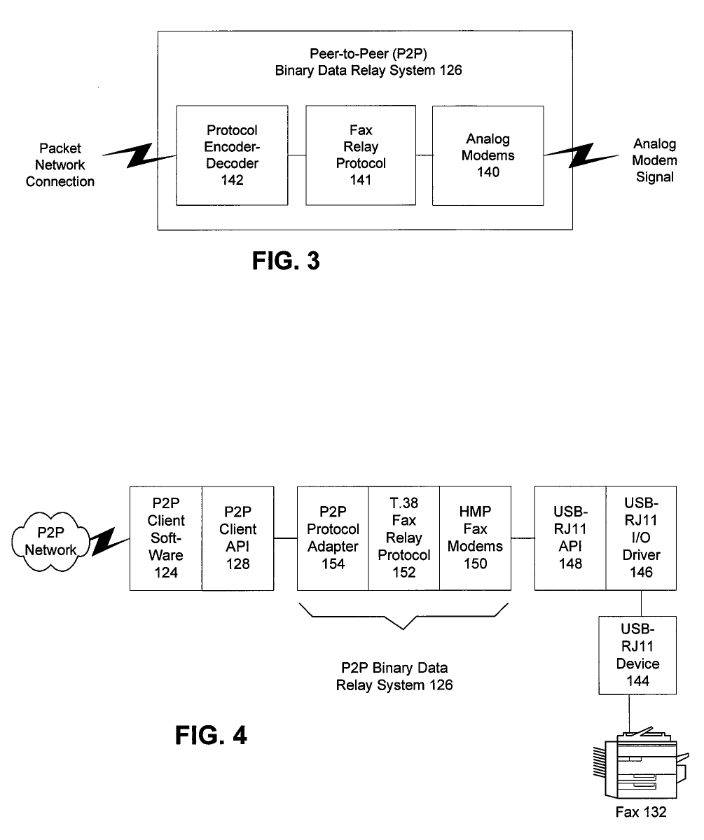

FIG. 3 is a diagram showing an embodiment of the binary data relay system 126 for modulating and demodulating the analog modem signal that the G3 fax terminal 132 uses to communicate across the PSTN's TDM network or a local connection between the fax terminal and a computer. The binary data relay system 126 modulates and demodulates the analog modem signal that the G3 fax terminal 132 uses to communicate across the PSTN's TDM network. The analog modems 140 transcode the analog signal into the machine code (ones and zeros) that represent the control messages and the facsimile images of the T.30-based transaction, and vice versa. The analog signal uses 128K-bits of network bandwidth to transmit, but the binary information being represented by that signal usually requires less than 30K bits. Moreover, the fax relay protocol 141 utilizes techniques that produce error-free images even when the network drops some packets of the image data due to network congestion. The protocol encoder-decoder 142 then places the information on the packet network 138, strictly adhering to the fax relay protocol 138 to ensure interoperability with the correspondent terminal.

As shown in FIG. 4, an embodiment of the binary data relay system 126 of FIG. 3 can be further decomposed to show how it utilizes third-party software for the interfaces with the local fax terminal 132 and the P2P network. The analog modem signal of the fax terminal 132 is digitized by a computer-to-POTS converter 144, such as an USB-RJ11 device, used to connect the fax terminal 132 to a client computer. RJ11 is the connector type for telephones and fax terminals. The USB-RJ11 device 144 uses software that executes on the client computer that includes an I/O driver 146, which directly interfaces with the hardware, and a USB-RJ11 application programming interface (API) 148, which gives external software, such as the binary data relay system's HMP fax modems 150, access to the digitized analog data provided by the USB-RJ11 device 144. HMP (host media processing) denotes the use of a PC to perform a function, such as the implementation of a modem, which is normally performed by an embedded resource, such as a modem board.

The HMP fax modems 150 demodulate the digitized analog fax-modem signal, deriving the binary facsimile data, which is then sent to the fax relay protocol software 152, such as the ITU T.38 fax relay protocol. In an open network rather than the closed overlay P2P network, the T.38 module 152 would send the packet data directly to the client computer's operating system's network-interface software, where it may be encapsulated in real time protocol (RTP) packets and then sent to the Internet Protocol (IP) network software for transmission via Internet Engineering Task Force's User Datagram Protocol (UDP) or Transmission Control Protocol (TCP) connections. However, in the present embodiment, the T.38 encoded data are sent to a P2P protocol adapter module 154 that suitably encodes the binary data as character data for transmission over the character-data transfer facility offered by the P2P network client API 128 and network application software 124.

A P2P network does not maintain a concentrated addressing and routing mechanism within the network, as is done by traditional telephone companies. A P2P network relies on the computers of the network participants to locate a called party, resource, and/or function. Moreover, the bandwidth needed to handle the transaction is provided by the participants, rather than the service provider. To keep bandwidth requirements low, low-bit-rate compression algorithms are sometimes used to transport a voice call. Many of these algorithms are specifically designed to compress human speech, resulting in their unsuitability to transport modem signals, which is necessary to transport a facsimile modem signal. The binary data relay system 126 implementing the fax relay function, as described above, is used to traverse the P2P network. However, the P2P network provider does not necessarily include functions to transfer binary data between two P2P endpoints. The preferred embodiment of the present invention, therefore, uses the character-data transfer mechanism to transport the binary data to implement the fax relay function.

Data flow in the opposite direction is simply the reverse. Packets are received from the P2P client API 128, decoded by the P2P protocol adapter 154, and sent to the T.38 fax relay protocol software 152 where the binary bits representing the fax image are extracted. This stream of binary data is handed off to the fax modems 150 for modulation and sending to the locally connected fax terminal 142 through the USB-RJ11 device 144.

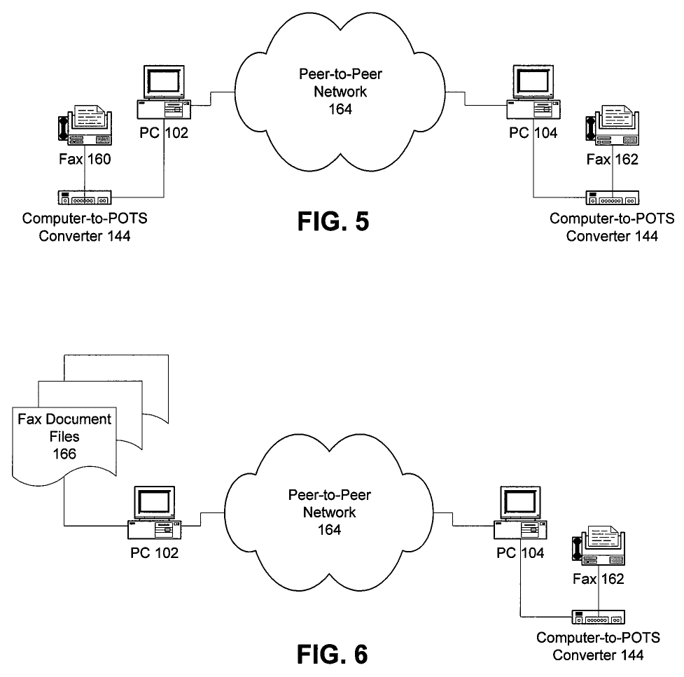

As shown in FIG. 5, the invention supports the T.30-based facsimile transaction between two standard G3 fax terminals 160, 162, each suitably connected to a computer 102, 104 equipped with an embodiment of the binary data system 126, by rendering the P2P network 164 transparent to the G3 fax terminals.

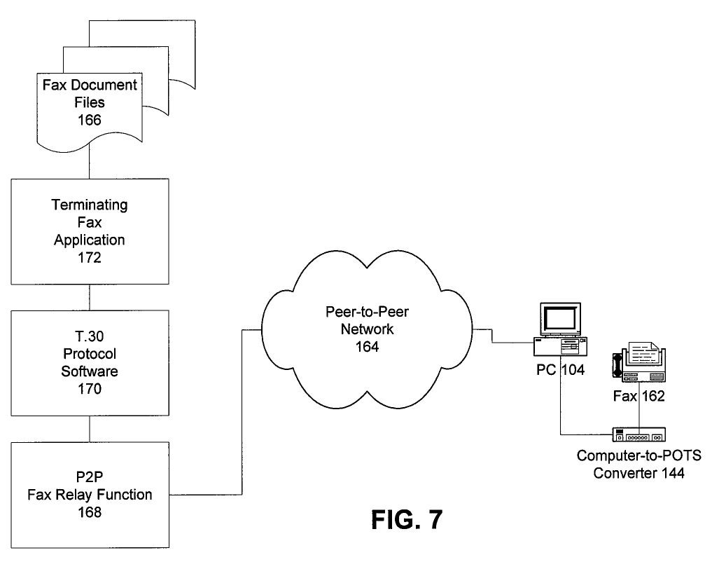

FIG. 6 shows a fax transaction between a legacy fax terminal 162 on the right, suitably connected via a computer-to-POTS converter 144 to a computer 104 equipped with an embodiment of the binary data relay system 126, with the computer 102 on the left, which terminates the fax transaction on the user's computer, rather than a connected fax terminal. The computer 102 on the left is also equipped with the binary data relay system 126. An embodiment required to implement the functions of the computer 102 on the left is shown in FIG. 7.

The combination of the P2P fax relay function 168 and the T.30 protocol function 170 is termed “Terminating Peer-to-Peer Fax”. By executing a specific command or establishing a different configuration, the user can direct the binary data relay system 126 to terminate the fax application 172 on the user's computer, for example in a facsimile-image compute file 166, rather than a connected fax terminal. Similarly, the user can configure the binary data relay system 126 to terminate the fax application 172 and send the resulting facsimile-image computer file 166 to the user via Internet e-mail (not shown).

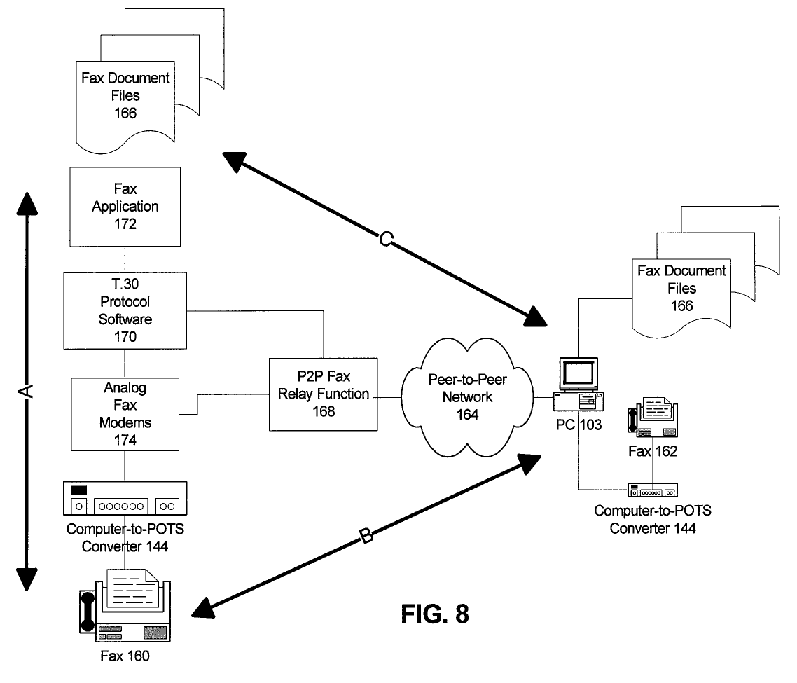

An embodiment of the binary data relay system 126 includes a function that supports the local termination of a fax that originates on the locally connected fax terminal, essentially turning the fax terminal into an image scanner. As a result, the function utilizes the fax modem software to implement the P2P fax relay function. Instead of interconnecting the modem function with the fax relay function, as shown in FIGS. 3 and 4, the modems 174 are connected directly to the local T.30 protocol software 170, as shown in FIG. 8, path A.

This gives rise to the functionality shown in FIG. 8, which shows the local-terminal termination via path A, fax-terminal-to-fax-terminal transactions, as shown in path B, and terminations into a computer file from the remote peer entity via path C.

The preferred embodiment of the binary relay system 126 uses the ITU T.38 protocol, but instead of using the UDP or TCP, the binary data relay system 126 converts the binary data into datagrams compatible with the proprietary protocol of the P2P network 164. For example, the P2P network developer supplies a mechanism or transfer facility for sending datagrams between the peer entities of a connection. These datagrams are defined as UTF-8 encoded with a byte of all zeros indicating the termination of the message. Each datagram message is limited to 1400 characters.

T.38 is a protocol that supports a T.30-based fax transaction across a packet data network in real time. For example, the T.38 protocol may specify that image data can be transferred as so-called Huffman-encoded bits. This stream of data may contain many bytes of 0x00 (zeros) in a standard frame.

As an exemplary embodiment for converting the binary data by the binary relay system 126, the maximum size T.38 packet will be limited to 300 bytes. Given this small size, a number of methods exist to permit encoding the binary data for transmission using a character-mode transport. A few examples of which are described hereafter.

The first and simplest is to convert each 4-bit value of the binary data to an 8-bit character using a mapping such as:

0000->00110000

0001->00110001

0010->00110010

0011->00110011

0100->00110100

0101->00110101

0110->00110110

0111->00110111

1000->00111000

1001->00111001

1010->00111010

1011->00111011

1100->00111100

1101->00111101

1110->00111110

1111->00111111.

Another mapping would convert 4-bit binary data to its hexadecimal text string equivalent. That mapping is:

0000->‘0’ (0x30)

0001->‘1’ (0x31)

. . .

1001->‘9’ (0x39)

1010->‘A’ (0x41)

1011->‘B’ (0x42)

. . .

1111->‘F’ (0x46).

Both of these encodings double the length of the binary data. But since a maximum packet is 300 octets, the doubled size is still within the 1400-octet limit.

The above encodings double the size of the data packet. A more efficient protocol is to use an escape octet (e.g. 0x1b, the ASCII ESC character) to define multi-octet sequences for the proscribed octets, 0x00 in this case. The escape sequences are:

0x1b 0x01->replaced with 0x00

0x1b 0x1b->replaced with 0x1b.

Binary data are scanned prior to the send-datagram method to convert all 0x1b octets present in the data to 0x1b 0x1b. All 0x00 will be translated to 0x1b 0x01. When a datagram is received all octets are scanned. Each 0x1b octet is removed and the next octet is converted based on the table:

0x01->0x00

0x1b->0x1b.

This encoding results in a smaller average expansion at the cost of variable size.

Many other coding schemes are possible, but these are offered as exemplary embodiments.

With reference back to FIG. 1, the memory 112 is defined herein as both volatile and nonvolatile memory and data storage components. Volatile components are those that do not retain data values upon loss of power. Nonvolatile components are those that retain data upon a loss of power. Thus, the memory may comprise, for example, random access memory (RAM), read-only memory (ROM), hard disk drives, floppy disks accessed via an associated floppy disk drive, compact discs accessed via a compact disk drive, magnetic tapes accessed via an appropriate tape drive, and USB flash drive accessed via a USB connection, or a combination of any two or more of these memory components. In addition, the RAM may comprise, for example, static random access memory (SRAM), dynamic random access memory (DRAM), or magnetic random access memory (MRAM), and other such devices. The ROM may comprise, for example, a programmable read-only memory (PROM), an erasable programmable read-only memory (EPROM), an electrically erasable programmable read-only memory (EEPROM), or other like memory device.

In addition, the processor 110 may represent multiple processors and the memory 112 may represent multiple memories that operate in parallel. In such a case, the local interface 114 may be an appropriate network that facilitates communication between any two of the multiple processors, between any processor and any one of the memories, or between any two of the memories, etc. The processor 110 may be of electrical, optical, or molecular construction, or of some other construction as can be appreciated by those with ordinary skill in the art.

The operating system 122 is executed to control the allocation and usage of hardware resources, such as the memory, processing time and peripheral devices in the computer system 102. In this manner, the operating system 122 serves as the foundation on which applications depend as is generally known by those with ordinary skill in the art.

Although the binary data relay system 126 is embodied in software or code executed by general purpose hardware as discussed above, as an alternative the same may also be embodied in dedicated hardware or a combination of software/general purpose hardware and dedicated hardware. If embodied in dedicated hardware, the binary data relay system 126 can be implemented as a circuit or state machine that employs any one of or a combination of a number of technologies. These technologies may include, but are not limited to, discrete logic circuits having logic gates for implementing various logic functions upon an application of one or more data signals, application-specific integrated circuits having appropriate logic gates programmable gate arrays (PGA), field-programmable gate arrays (FPGA), or other components, etc. Such technologies are generally well known by those skilled in the art and, consequently, are not described in detail herein.

Also, where the binary data relay system 126 comprises software or code, which comprises an ordered listing of executable instructions for implementing logical functions, it can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the binary data relay system 126 for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of the present invention includes embodying the functionality of the preferred embodiments of the present invention in logic embodied in hardware or software-configured mediums.

Exemplary embodiments include:

A. A system that enables real-time streaming transport of binary data through a data network between first and second computers configured for peer-to-peer communications.

B. The system of claim A, wherein the binary data are facsimile data.

C. The system of claim A, wherein each of the computers is equipped with peer-to-peer-network-enabling means for eliminating the need for the binary data to be transported across the public switched telephone network (PSTN) and wherein the peer-to-peer communications do not take place through the PSTN.

D. The system of claim A, wherein the data network is a packet-based data network.

E. The system of claim A, further comprising means for encoding the binary data as character data and means for communicating the character data through the data network.

F. The system of claim B, further comprising first and second G3 fax terminals interfaced respectively with the first and second computers and wherein the G3 fax terminals can communicate facsimile data between each other through the computers.

G. The system of claim F, wherein the first and second G3 facsimile terminals are interfaced respectively to the first and second computers via computer-to-POTS converters.

H. The system of claim F, wherein facsimile data are terminated at one of the computers rather than the G3 terminal.

I. The system of claim H, further comprising means for sending the facsimile data terminated at the computer to a recipient via e-mail.

J. The system of claim F, further comprising means for enabling the sending of a facsimile image from one of the G3 facsimile terminals to its respective computer to which it is connected, essentially turning the G3 facsimile terminal into an image scanner.

K. A method, comprising:
real-time communicating of binary data through a peer-to-peer data network from a first computer to a second computer.

L. The method of claim K, wherein the binary data are facsimile data and the data network is a packet-based data network.

M. The method of claim K, wherein each of the computers is equipped with peer-to-peer-network enabling means for eliminating the need for the binary data to be transported across the public switched telephone network (PSTN) and wherein the peer-to-peer communications do not take place through the PSTN.

N. The method of claim K, further comprising encoding the binary data as character data and communicating the character data through the data network from the first computer to the second computer.

O. The method of claim K, wherein the binary data are facsimile data and further comprising communicating the facsimile data from a first G3 facsimile terminal to the first computer.

P. The method of claim O, wherein the facsimile data are communicated from the first G3 facsimile terminal to the first computer via a computer-to-POTS converter.

Q. The method of claim O, wherein the facsimile data are terminated at the second computer.

R. The method of claim Q, further comprising sending the facsimile data from the second computer to a recipient via e-mail.

S. The method of claim O, further comprising enabling the sending of a facsimile image from the first G3 facsimile terminal to the first computer to which it is connected, essentially turning the first G3 facsimile terminal into an image scanner.

T. A program embodied in a computer readable medium for communicating binary data through a data network, comprising:
code that enables real-time streaming transport of the binary data through the data network between first and second computers configured for peer-to-peer communications, and
code that encodes the binary data as character data and communicating the character data through the data network from the first computer to the second computer.

Although the invention is shown and described with respect to certain embodiments, it should be emphasized that the above-described embodiments of the present invention, particularly, any “preferred” embodiments, are merely possible examples of implementations set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

1. A system that enables real-time streaming transport of binary data through a data network between first and second computers configured for peer-to-peer communications.

2. The system of claim 1, wherein each of the computers is equipped with peer-to-peer-network-enabling means for eliminating the need for the binary data to be transported across the public switched telephone network (PSTN) and wherein the peer-to-peer communications do not take place through the PSTN.

3. The system of claim 1, further comprising means for encoding the binary data as character data and means for communicating the character data through the data network.

4. The system of claim 3, wherein the binary data are facsimile data and further comprising first and second G3 fax terminals interfaced respectively with the first and second computers and wherein the G3 fax terminals can communicate facsimile data between each other through the computers.

5. The system of claim 4, wherein the data network is a packet-based data network and facsimile data are terminated at one of the computers rather than the G3 terminal.

6. A method, comprising:
real-time communicating of binary data through a peer-to-peer data network from a first computer to a second computer.

7. The method of claim 6, further comprising encoding the binary data as character data and communicating the character data through the data network from the first computer to the second computer.

8. The method of claim 7, wherein the binary data are facsimile data and further comprising communicating the facsimile data from a first G3 facsimile terminal to the first computer.

9. The method of claim 8, further comprising enabling the sending of a facsimile image from the first G3 facsimile terminal to the first computer to which it is connected, essentially turning the first G3 facsimile terminal into an image scanner.

10. A system comprising:
means for enabling real-time streaming transport of the binary data through the data network between first and second computers configured for peer-to-peer communications through the data network, and
means for encoding the binary data as character data and communicating the character data through the data network from the first computer to the second computer.
